(19) United States
(12) Patent Application Publication
(10) Pub. No.: US 2018/0373191 A1
(43) Pub. Date: Dec. 27, 2018

(54) SHEET FEED UNIT AND IMAGE FORMING APPARATUS THEREWITH

(71) Applicant: KYOCERA Document Solutions Inc., Osaka (JP)

(72) Inventor: Hideaki DOYO, Osaka (JP)

(73) Assignee: KYOCERA Document Solutions Inc., Osaka (JP)

(21) Appl. No.: 16/014,873

(22) Filed: Jun. 21, 2018

(30) Foreign Application Priority Data
Jun. 22, 2017 (JP) 2017-122108

(51) Int. Cl. G03G 15/00; G03G 15/20; G03G 15/08

(52) U.S. Cl. CPC G03G 15/6511; G03G 15/0836; G03G 15/2028

(57) ABSTRACT

A sheet feed unit has a unit housing, a roller holder, a pickup roller, a feed roller, a separating member, a pressing mechanism, and a pressing force adjusting mechanism. The pressing mechanism has a pressing member pressing the swinging end of the roller holder, a link member making contact with the pressing member, and a first biasing member biasing the link member toward the pressing member. The pressing force adjusting mechanism has an arm member supported reciprocatably in the sheet width direction and supporting the link member movably in the sheet width direction, and an operation dial making the arm member reciprocate. The pressing force adjusting mechanism changes the biasing force of the first biasing member on the pressing member according to the movement amount of the arm member to adjust the pressing force of the pickup roller against the top face of sheets placed on a sheet placement plate.

### INCORPORATION BY REFERENCE

This application is based upon and claims the benefit of priority from the corresponding Japanese Patent Application No. 2017-122108 filed on Jun. 22, 2017, the entire contents of which are incorporated herein by reference.

### BACKGROUND

The present disclosure relates to a sheet feed unit for feeding sheets of paper or the like to be fed to an apparatus, and to an image forming apparatus incorporating such a sheet feed unit. More particularly, the present disclosure relates to a method of adjusting the pressing force of a pickup roller for feeding out sheets.

Sheet feed cassettes are used in image forming apparatuses as exemplified by copiers and printers for the purpose of feeding cut paper or the like. A large number of unprinted sheets are stored in a sheet feed cassette so that, by a sheet feed unit provided near the sheet feed cassette, one sheet after another is separated and fed out from the topmost layer of a stack of sheets stored in the cassette.

A sheet feed unit includes expendables such as a sheet feed roller and a pickup roller, and so is designed to be easy to mount in and remove from the main body of an image forming apparatus on the occasion of maintenance or replacement of those expendables.

Some sheet feed cassettes include a sheet placement plate on the top face of which sheets are placed. The sheet placement plate is supported on the inner bottom face of a cassette body with an upstream-side end part of it in the sheet feed direction as a swing pivot so that a downstream-side end part of it in the sheet feed direction can, as a swinging end, move up and down. The swinging end of the sheet placement plate is lifted up by a driving means, such as a lift motor, provided in the image forming apparatus. Thus, the downstream-side end of the sheets placed on the sheet placement plate is pressed against a pickup roller arranged in the sheet feed unit to achieve sheet feeding. Here, for stable sheet feeding free from failed or double feeding, the pressing force of the pickup roller against the top face of the sheets placed on the sheet placement plate is an important factor.

The adequate value of the pressing force of the pickup roller varies with the type, size, and the like of the sheets that are fed. Thus, the pressing force of the pickup roller needs to be adjusted to suit the type, size, and the like of sheets. For example, a known sheet feed device has a pressing force setting table that allows selection and setting of one of a plurality of varying pressing forces based on a sheet size detection signal from a sheet size detecting means so that the pressing force of a pressing means can be changed based on the pressing force setting table.

For another example, in a known sheet material conveying mechanism, the winding strength of the winding of a torsion spring for pressing down a roller support shaft is adjusted by adjusting the engagement between an engaging arm portion protruding from a winding portion and a first and a second stopper provided on a roller holder so that the pressing force of a roller is thereby adjusted. For yet another example, a known sheet feed device is provided with a sheet feed pressure adjusting means including a sheet feed pressure spring, a slider, and a sheet feed pressure control motor wherein, as the sheet feed pressure control motor is driven and the slider moves, the expanded length of the sheet feed pressure spring is varied and the sheet feed pressure is thereby adjusted.

### SUMMARY

According to one aspect of the present disclosure, a sheet feed unit includes a unit housing, a roller holder, a pickup roller, a feed roller, a separating member, a pressing mechanism, and a pressing force adjusting mechanism. The unit housing is removably mounted in an apparatus main body. The roller holder is swingably supported on the unit housing. The pickup roller is rotatably supported at the swinging end of the roller holder, and rotates, while in contact with the top face of sheets placed on a sheet placement plate in a sheet feed cassette removably mounted in the apparatus main body, thereby to feed out the sheets. The feed roller is arranged on the downstream side of the pickup roller in the sheet feed direction. The separating member forms a nip with the feed roller, and feeds the sheets one by one while separating them. The pressing mechanism includes a pressing member which presses down the swinging end of the roller holder, a link member of which a tip end part makes contact with the pressing member, and a first biasing member which biases the link member toward the pressing member. The pressing force adjusting mechanism includes an arm member which is supported so as to be reciprocatable in the sheet width direction perpendicular to the sheet feed direction on the unit housing and which supports the link member movably in the sheet width direction, and an operation dial which makes the arm member reciprocate. The pressing force adjusting mechanism changes the biasing force acting from the first biasing member via the link member to the pressing member according to the movement amount of the arm member, and thereby adjusts the pressing force of the pickup roller against the top face of the sheets placed on the sheet placement plate.

Further features and advantages of the present disclosure will become apparent from the description of embodiments given below.

### BRIEF DESCRIPTION OF THE DRAWINGS

FIG. 1 is a side sectional view showing an internal construction of an image forming apparatus incorporating a sheet feed unit according to the present disclosure;

FIG. 2 is a perspective view, as seen from above the front face side, of a sheet feed cassette that is mounted in the image forming apparatus;

FIG. 3 is a perspective view, as seen from above, of the sheet feed unit according to one embodiment of the present disclosure that is mounted in the image forming apparatus;

FIG. 4 is a perspective view of a pressing mechanism, a pressing force adjusting mechanism, and a retracting mechanism provided in the sheet feed unit;

FIG. 5 is an enlarged view of a contact part between the pressing mechanism and the roller holder as seen from above;

FIG. 6 is an enlarged view of the contact part between the pressing mechanism and the roller holder as seen from below;

FIG. 7 is a plan view of a first gear as seen from the side of its web face facing a unit housing; and

FIG. 8 is a side view showing how first ratchet teeth on the first gear and second ratchet teeth on the unit housing mesh with each other.

### DETAILED DESCRIPTION

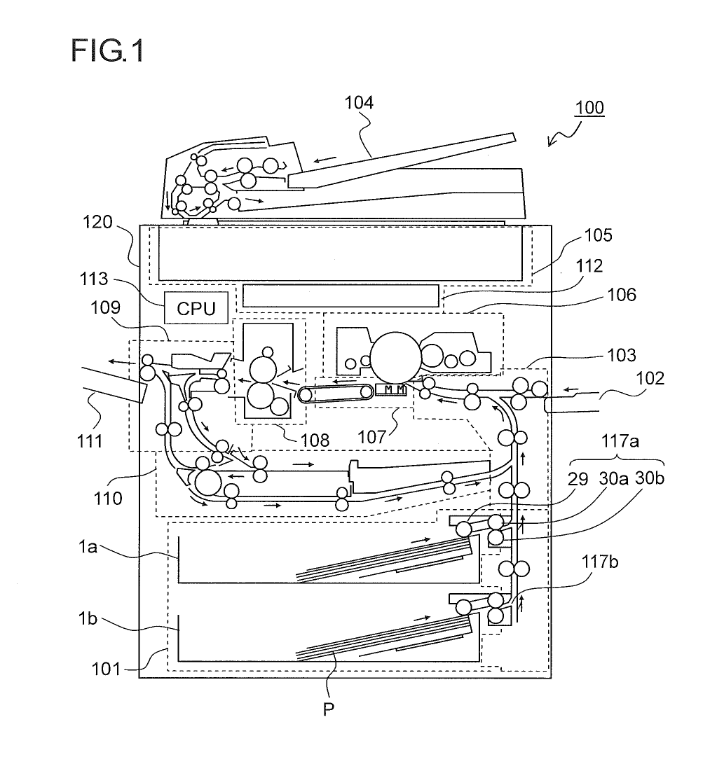

Hereinafter, with reference to the accompanying drawings, an embodiment of the present disclosure will be described. FIG. 1 is a side sectional view showing an internal construction of an image forming apparatus 100 incorporating sheet feed units 117a and 117b according to the present disclosure. In the diagram, solid-line arrows indicate conveying passages for and conveying directions of sheets.

As shown in FIG. 1, in a lower part of the image forming apparatus 100, a cassette-type sheet feeding section 101 is arranged. The cassette-type sheet feeding section 101 includes two sheet feed cassettes 1a and 1b. Inside the sheet feed cassettes 1a and 1b, a stack of sheets P is stored, which can be unprinted cut paper or the like. By sheet feed units 117a and 117b provided in an apparatus main body 120 of the image forming apparatus 100, one sheet after another is separated and fed out from the stack of sheets P. The sheet feed units 117a and 117b each include a pick-up roller 29a, a feed roller 30a, and a retard roller 30b. The pick-up roller 29a rotates while in contact with the top face of the stack of sheets P, and thereby feeds out one to a plurality of sheets from the stack of sheets P. The feed roller 30a forms a nip with the retard roller 30b, and feeds one by one, while separating, the sheets fed out by the pick-up roller 29a.

A manual sheet feeding section 102 is provided outside an upper part of the right side face of the image forming apparatus 100. The manual sheet feeding section 102 is for placement of sheets of different sizes and thicknesses from those in the cassette-type sheet feeding section 101, and sheets that have to be fed in one by one, such as an OHP sheet, envelope, postcard, invoice, or the like.

Inside the image forming apparatus 100, a sheet conveying section 103 is arranged. The sheet conveying section 103 is located to the right, that is, on the downstream side in the sheet feeding direction, of the cassette-type sheet feeding section 101. The sheet conveying section 103 is located to the left, that is, on the downstream side in the sheet feeding direction, of the manual sheet feeding section 102. A sheet fed out from the cassette-type sheet feeding section 101 is conveyed vertically upward along a side face of the apparatus main body 120 by the sheet conveying section 103. A sheet P fed out from the manual sheet feeding section 102 is conveyed horizontally by the sheet conveying section 103.

On the top face of the image forming apparatus 100, a document conveying device 104 is arranged, and under the document conveying device 104, an image reading section 105 is arranged. When copying a document, a user places on the document conveying device 104 a document comprising a plurality of sheets having drawn on them images such as characters, figures, patterns, or the like. The document conveying device 104 separates and feeds out one sheet after another from the document, and the image reading section 105 reads its image data.

On the downstream side of the sheet conveying section 103 in the sheet conveying direction, under the image reading section 105, an image forming section 106 and a transfer section 107 are arranged. In the image forming section 106, based on the image data read by the image reading section 105, an electrostatic latent image of the document image is formed, and the electrostatic latent image is then developed to form a toner image. On the other hand, in synchronism with the formation of the toner image in the image forming section 106, a sheet P is conveyed from the cassette-type sheet feeding section 101 via the sheet conveying section 103 to the transfer section 107. The toner image formed in the image forming section 106 is transferred to the sheet P in the transfer section 107.

On the downstream side of the transfer section 107, a fixing section 108 is arranged. The sheet P having an unfixed toner image transferred to it in the transfer section 107 is conveyed to the fixing section 108. The sheet P passes through a nip portion between a fixing roller pair comprising a heating roller and a pressing roller, and thereby the unfixed toner image on the sheet P is fixed to become a permanent image.

On the downstream side of the fixing section 108, near the left side face of the image forming apparatus 100, a discharge/branch section 109 is arranged. When no duplex printing is performed, the sheet discharged from the fixing section 108 is discharged via the discharge/branch section 109 onto a sheet discharge tray 111 provided outside the left side face of the image forming apparatus 100.

Under a part extending from the image forming section 106 to the discharge/branch section 109, over the cassette-type sheet feeding section 101, a duplex printing unit 110 is arranged. When duplex printing is performed, the sheet discharged from the fixing section 108 is conveyed via the discharge/branch section 109 to the duplex printing unit 110. The sheet conveyed to the duplex printing unit 110 is reversed top side down by switching back, and is conveyed once again via the sheet conveying section 103 to the transfer section 107, with the side having no image formed on it facing up.

In the image forming apparatus 100, an operation potion 112 and a control portion 113 are arranged. The operation potion 112 includes a liquid crystal display portion and LEDs, and is configured, for example, to indicate the status of the image forming apparatus 100 and to display the progress of image formation and the number of copies. The operation potion 112 also includes a Start button, which the user operates to start image formation; a Stop/Clear button, which the user uses, among others, to stop image formation; and a Reset button, which the user uses to bring the various settings of the image forming apparatus 100 back to the default settings. The control portion 113 exchanges control signals and status signals with different devices within the image forming apparatus 100.

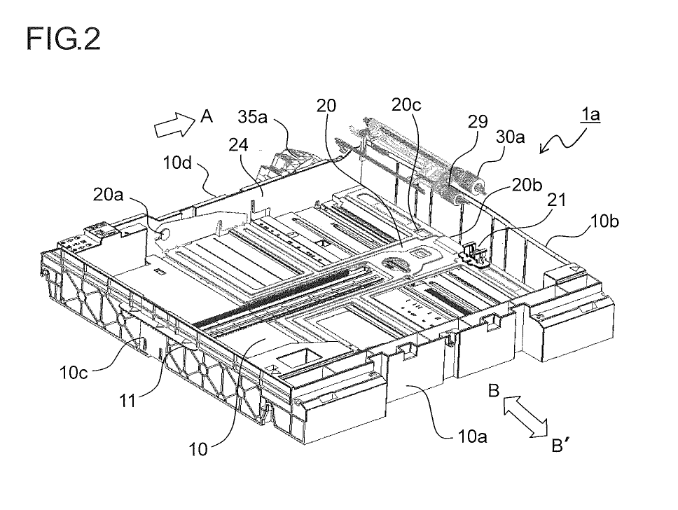

Next, with reference to FIG. 1 and also FIG. 2, a structure of the sheet feed cassette 1a, which is used in a removably mounted state in the image forming apparatus 100, will be described in detail. FIG. 2 is an exterior perspective view of the sheet feed cassette 1a as seen from above the front face side. While the structure of the sheet feed cassette 1a will be described below, the sheet feed cassettes 1b has quite the same structure.

The sheet feed cassette 1a is housed in, so as to be insertable into and extractable out of, the cassette-type sheet feeding section 101 in the apparatus main body 120 shown in FIG. 1. A cassette body 10 has wall parts 10a to 10d formed upright in a peripheral part of the bottom face along its four sides, and is thus formed in the shape of a flat box open at the top face, so that a stack of sheets P (see FIG. 1) can be accommodated in it by being stacked from the top face direction. Inside the image forming apparatus 100, over the sheet feed cassette 1a, outside the wall part 10b located on the downstream side of the cassette body 10 in the sheet feeding direction (arrow A direction), a sheet feed unit 117a (see FIG. 1) is arranged, and sheets separated one by one from the stack of sheets P are fed in the arrow-A direction in FIG. 2.

Outside the wall parts 10b and 10c parallel to the insertion/extraction direction (arrow BB′ direction) of the sheet feed cassette 1a, a pair of guide rails 11 is fitted. In the cassette-type sheet feeding section 101, a pair of rail support portions (unillustrated) is provided which slidably supports the guide rails 11, and as the guide rails 11 are slid along the rail support portions, the sheet feed cassette 1a can be inserted into and extracted out of the image forming apparatus 100.

On an inner bottom face of the cassette body 10, a sheet placement plate 20 is provided. The sheet placement plate 20 is supported, with a boss potion 20a on the upstream side in the sheet feeding direction as a swing pivot, on the wall parts 10a and 10d of the cassette body 10, and is swingable up and down with a down-stream side end part in the sheet feeding direction as a swinging end 20b. The sheet placement plate 20 is so configured that the swinging end 20b is movable up and down with the help of a lift mechanism (unillustrated) coupled to a lift motor 35a in the apparatus main body 120 of the image forming apparatus 100.

The swinging end 20b of the sheet placement plate 20 is fitted with a lock pin 21 for fastening the sheet placement plate 20 to the bottom face of the cassette body 10. When the sheet feed cassette is transported, the lock pin 21 prevents noise from and breakage of the sheet placement plate 20 resulting from the sheet placement plate 20 swinging. When the sheet feed cassette 1a is used, the lock pin 21 is removed, and a stack of sheets P is placed on the sheet placement plate 20.

Inside the cassette body 10, a pair of width restricting cursors 24 is provided which is arranged upright, along the sheet feeding direction (arrow-A direction). The width restricting cursors 24 make contact with side faces of the stack of sheets P from both sides in the sheet width direction which is perpendicular to the sheet feeding direction, and position the stack of sheets P in the width direction so as to locate it in a sheet feeding position from where sheets are fed out by the sheet feed unit 117a. The width restricting cursors 24 are movable along a cursor movement groove (unillustrated) which is provided in the inner bottom face of the cassette body 10 so as to extend in the sheet width direction. The pair of width restricting cursors 24 is configured such that, by the action of a rack-and-pinion mechanism (unillustrated) provided under it, when one is moved, the other moves simultaneously. Here, the pair of width restricting cursors 24 moves symmetrically left-to-right about the center line of the stack of sheets P in the width direction.

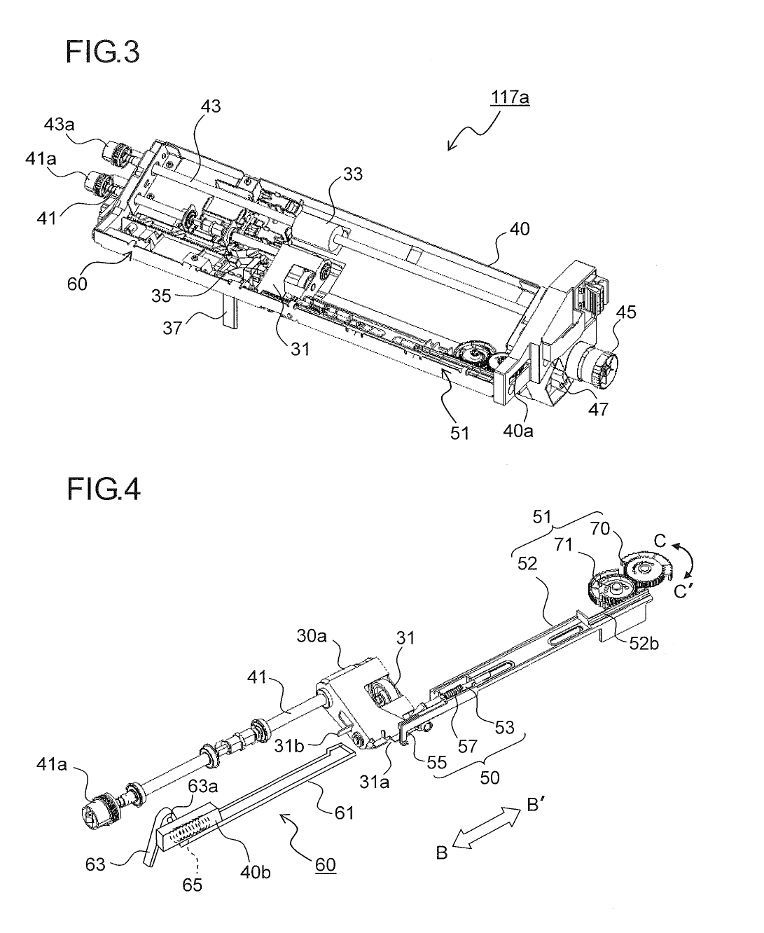

FIG. 3 is a perspective view of the sheet feed unit 117a as seen from above. The sheet feed unit 117b has quite the same structure as the sheet feed unit 117a shown in FIG. 3. The sheet feed unit 117a is supported in a removably mounted state in a unit insertion portion (unillustrated) formed between a pair of side face frames which is arranged opposite each other on the rear and front sides of the apparatus main body 120.

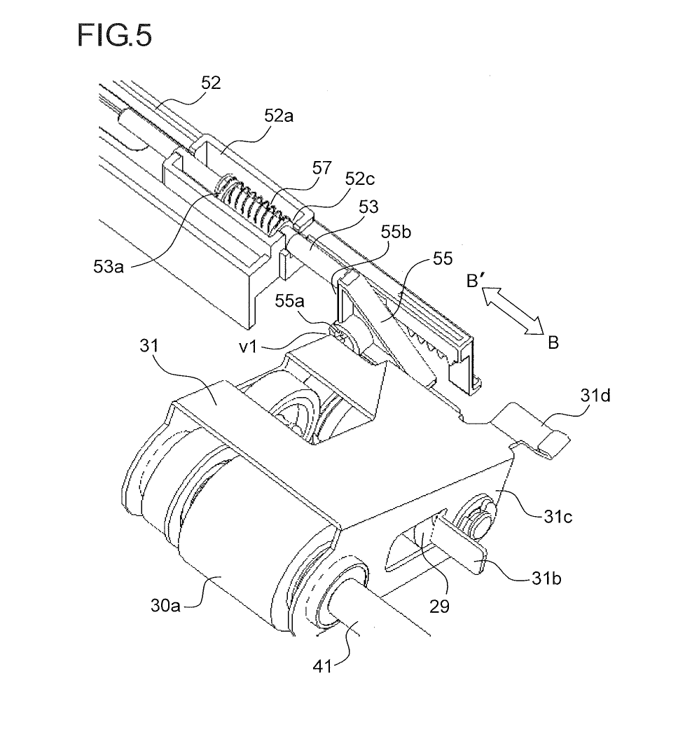

In the sheet feed unit 117a, a roller holder 31 is swingably supported on a unit housing 40 with a rotary shaft 41 of a feed roller 30a (see FIG. 2) as a pivot. A tip end part of the rotary shaft 41 is fitted with a driving input coupling 41a which meshes with a driving output coupling (unillustrated) in the cassette-type sheet feeding section 101 (see FIG. 1). At the swinging end 31c of the roller holder 31 (see FIG. 5), a pickup roller 29 (see FIG. 2) is rotatably supported. The pickup roller 29 and the feed roller 30a are coupled together by a gear train (unillustrated), and as the rotary shaft 41 rotates, the pickup roller 29 and the feed roller 30a rotate in the same direction (sheet feeding direction). The swinging end 31c of the roller holder 31 is provided with a restricting piece 31d. When the sheet placement plate 20 is lowered, the restricting piece 31d makes contact with the unit housing 40 so as to restrict downward swinging of the roller holder 31.

On the unit housing 40, a rotary shaft 43 of a conveying roller 33 is rotatably supported parallel to the rotary shaft 41. To one end part of the rotary shaft 43, a driving input coupling 43a is fitted which meshes with a driving output coupling (unillustrated) in the cassette-type sheet feeding section 101. To another end part of the rotary shaft 43, a handle 45 for manually rotating the conveying roller 33 in the direction opposite to the sheet feeding direction is coupled via a gear train. When a sheet is jammed in the sheet feed unit 117a, a user can remove the sheet by turning the handle 45 in a predetermined direction and thereby rotating the conveying roller 33. Near the handle 45, a lever 47 is provided by which a retard roller 30b (see FIG. 1) can be pressed against and released from the feed roller 30a.

Near the roller holder 31, a top face detection sensor 35 is arranged. The top face detection sensor 35 is a PI (photointerrupter) sensor which includes a detection portion having a light emitting portion and a light receiving portion, and a light path in the detection portion of the top face detection sensor 35 is blocked and opened by a light shading plate 31b (see FIG. 4) formed in the roller holder 31. When no sheet feeding is being performed, that is, with the sheet placement plate 20 (see FIG. 2) unraised, the light shading plate 31b is retracted below away from the detection portion of the top face detection sensor 35, and the light receiving signal level of the detection portion is High.

When sheet feeding is performed and the swinging end 20b of the sheet placement plate 20 rises, the top face of the stack of sheets P placed on the sheet placement plate 20 (if no stack of sheets P is placed, then the sheet placement plate 20) makes contact with the pickup roller 29. The pickup roller 29 is then pushed up together with the roller holder 31, and the light shading plate 31b formed on the roller holder 31 also moves up. As a result, the light shading plate 31b blocks the light path in the detection portion of the top face detection sensor 35, and thus the light receiving signal level of the detection portion turns from High to Low. This makes it possible to detect the height of the pickup roller 29, that is, the top face position of the stack of sheets P.

In the sheet feed unit 117a, a PE detection actuator 37 for detecting the presence of sheets on the sheet placement plate 20 is provided. After the sheet feed cassette 1a having a stack of sheets P placed on the sheet placement plate 20 is inserted, when the sheet placement plate 20 is raised a predetermined amount, the PE detection actuator 37 swings, and the light receiving signal level of a PE detection sensor (unillustrated) provided in the cassette-type sheet feeding section 101 turns from Low to High.

In the sheet placement plate 20, a slit 20c (see FIG. 2) is formed through which the PE detection actuator 37 can pass. As the sheets in the sheet feed cassette 1a decrease with the progress of printing, the sheet placement plate 20 rises accordingly, and thus the angle of the PE detection actuator 37 is kept constant. When the sheets in the sheet feed cassette 1a run out, the PE detection actuator 37 passes through the slit 20c in the sheet placement plate 20, and the PE detection actuator 37 pivots. As a result, the light receiving signal level of the PE detection sensor turns back to Low, and it is thus detected that the sheets in the sheet feed cassette 1a have run out.

The sheet feed unit 117a is also provided with a pressing mechanism 50 which presses the pickup roller 29 onto the top face of a stack of sheets P placed on the sheet placement plate 20, a pressing force adjusting mechanism 51 which adjusts the pressing force of the pickup roller 29, and a retracting mechanism 60 by which the pickup roller 29 can be retracted when the sheet feed cassette 1a is inserted and extracted.

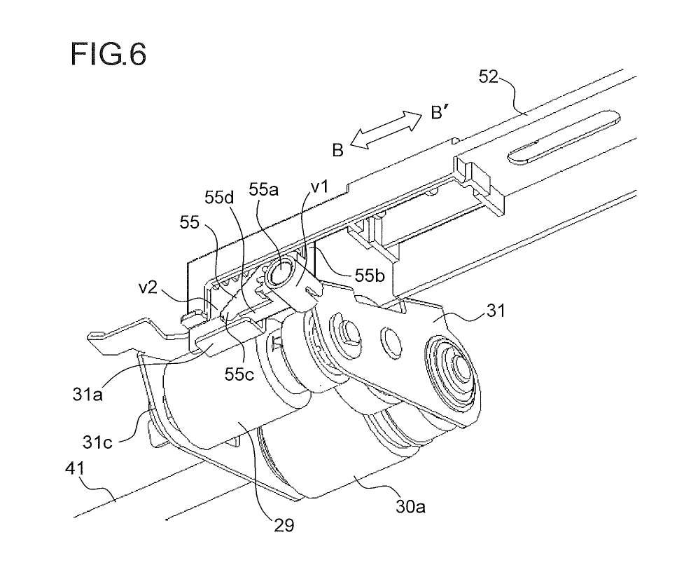

FIG. 4 is a perspective view of the pressing mechanism 50, the pressing force adjusting mechanism 51, and the retracting mechanism 60 provided in the sheet feed unit 117a. FIG. 5 and FIG. 6 are enlarged views of the contact part between the pressing mechanism 50 and the roller holder 31 as seen from above and below, respectively. FIG. 5 and FIG. 6 show a state where the pickup roller 29 (roller holder 31) is arranged in the raised position (a retracted position, which will be described later). The pressing mechanism 50 includes a link member 53, a pressing member 55, and a first coil spring (first biasing member) 57. The pressing force adjusting mechanism 51 includes an arm member 52, a first gear 70, and a second gear 71.

The arm member 52 is supported on the unit housing 40 (see FIG. 3) so as to be reciprocatable in the arrow BB′ direction. The link member 53 is in the shape of a rod with a circular cross section, and is supported, so as to be reciprocatable in the arrow BB′ direction, on a guide portion 52a formed in one end part (at the roller holder 31 side) of the arm member 52.

The pressing member 55 is a member in a triangular shape as seen on a plan view, and is supported on the housing unit 40 so as to be pivotable about a rotary shaft 55a provided at a first vertex v1 of the triangle as a pivot. A pressed face 55b (first side) extending upward from the rotary shaft 55a makes contact with the tip end of the link member 53. At a second vertex v2 at the end of a under face 55d (second side) extending in the horizontal direction from the first vertex v1, a pressing portion 55c is formed which presses a depressed piece 31a on the roller holder 31. When the pickup roller 29 is lowered and arranged in a sheet feeding position, which will be described later, the pressing portion 55c makes contact with the depressed piece 31a, so that the rotation of the pressing member 55 is restricted.

The first coil spring 57 is fitted outside the link member 53. One end part (at the pressing member 55 side) of the first coil spring 57 is locked by a first locking portion 52c formed in one end part (at the pressing member 55 side) of the guide portion 52a, and another end part of the first coil spring 57 is locked by a second locking portion 53a formed on the link member 53. The link member 53 is thus biased in the direction (arrow B direction) approaching the pressing member 55 by the biasing force (contraction force) of the first coil spring 57.

The first gear 70 and the second gear 71 are, in a position where gear teeth formed on their respective circumferential surfaces mesh with each other, supported rotatably on the housing unit 40. The gear teeth of the second gear 71 mesh with rack teeth 52b formed on the arm member 52. A part of the circumferential surface of the first gear 70 is exposed out of the sheet feed unit 117a through an opening 40a formed in an upstream-side part of the unit housing 40 in its inserting direction (at the right side in FIG. 3, that is, at the front face side of the image forming apparatus 100).

The retracting mechanism 60 includes a holder support member 61, a contact lever (contact member) 63, and a second coil spring (second biasing member) 65. The holder support member 61 is arranged so as to be reciprocatable in the insertion/extraction direction (arrow BB′ direction) of the sheet feed cassette 1a relative to the unit housing 40. The contact lever 63 extends downward from a pivot 63a which protrudes from the unit housing 40 in a direction perpendicular to the insertion direction (arrow B direction) of the sheet feed cassette 1a. The holder support member 61 and the contact lever 63 are coupled together by a rack-and-pinion mechanism (unillustrated) composed of a pinion gear fitted to the pivot 63a and a rack gear formed on the top face of the holder support member 61, and as the contact lever 63 swings in the arrow BB′ direction, also the holder support member 61 reciprocates in the arrow BB′ direction. The second coil spring 65 is arranged along the arrow BB′ direction in a spring housing portion 40b in the unit housing 40, and biases the holder support member 61 in the arrow B′ direction.

With the sheet feed cassette 1a uninserted, the holder support member 61 is positioned in a state where it is inserted under the roller holder 31 and is pressed against a restricting part (unillustrated) in the unit housing 40 by the biasing force of the second coil spring 65. The roller holder 31 is supported in a state (retracted position) where it is raised, by the holder support member 61, against its own weight and the pressing force of the pressing member 55. In this way, when the sheet feed cassette 1a is inserted in the cassette-type sheet feeding section 101, interference between the cassette body 10 and the pickup roller 29 is prevented.

When the sheet feed cassette 1a is inserted up to a predetermined position in the cassette-type sheet feeding section 101, the wall part 10d (see FIG. 2) on the downstream side in the insertion direction presses the contact lever 63, which thus pivots in the arrow B direction against the biasing force of the second coil spring 65. As a result, the holder support member 61 retracts from under the roller holder 31, and the roller holder 31 lowers under its own weight and the pressing force of the pressing member 55 so as to be arranged in the sheet feeding position in contact with the top face of the stack of sheets P.

The depressed position (depressed piece 31a) at which the roller holder 31 is depressed by the pressing member 55 of the pressing mechanism 50 and the support position at which the roller holder 31 is supported by the holder support member 61 of the retracting mechanism 60 are at approximately equal distances from the swing pivot (rotary shaft 41) of the roller holder 31.

Next, a procedure for adjusting the pressing force of the pickup roller 29 by the pressing force adjusting mechanism 51 will be described. As described previously, the link member 53 is supposed on the guide portion 52a of the arm member 52, with an end part of the first coil spring 57 in the arrow B direction locked by the guide portion 52a and an end part of the first coil spring 57 in the arrow B′ direction locked by the link member 53. During ordinary use (during sheet feeding) except during maintenance, the tip end of the link member 53 is in contact with the pressed face 55b of the pressing member 55. When the first gear 70 is rotated in the arrow C direction, a driving force is transmitted via the second gear 71 to the rack teeth 52b of the arm member 52, and the arm member 52 moves in the arrow B direction. As the arm member 52 moves in the arrow B direction, the first coil spring 57, of which opposite end parts are fixed to the arm member 52 and the link member 53, is expanded.

As a result, the contraction force (restoring force) of the first coil spring 57 is transmitted to the link member 53. This increases the force with which the link member 53 presses the pressed face 55b of the pressing member 55, and accordingly increases the force with which the pressing portion 55c presses down the depressed piece 31a on the roller holder 31. Thus, the roller holder 31 is acted upon strongly not only by its own weight but also by the pressing force of the pressing member 55. This increases the pressing force of the pickup roller 29 against the top face of the stack of sheets P on the sheet placement plate 20.

On the other hand, when the first gear 70 is rotated in the arrow C′ direction, a driving force is transmitted via the second gear 71 to the rack teeth 52b of the arm member 52, and the arm member 52 moves in the arrow B′ direction. This reduces the expanded length of the first coil spring 57, and accordingly reduces the contraction force (restoring force) of the first coil spring 57 that is transmitted to the link member 53. This reduces the force with which the link member 53 presses the pressed face 55b of the pressing member 55, and accordingly reduces the force with which the pressing portion 55c presses down the depressed piece 31a on the roller holder 31. This reduces the pressing force of the pickup roller 29 against the top face of the stack of sheets P on the sheet placement plate 20. The expanded length of the first coil spring 57 is proportional to the movement distance of the arm member 52, and thus also the restoring force of the first coil spring 57 and the pressing force of the pressing member 55 are proportional to the movement distance of the arm member 52. In the manner described above, the pressing force of the pickup roller 29 can be adjusted.

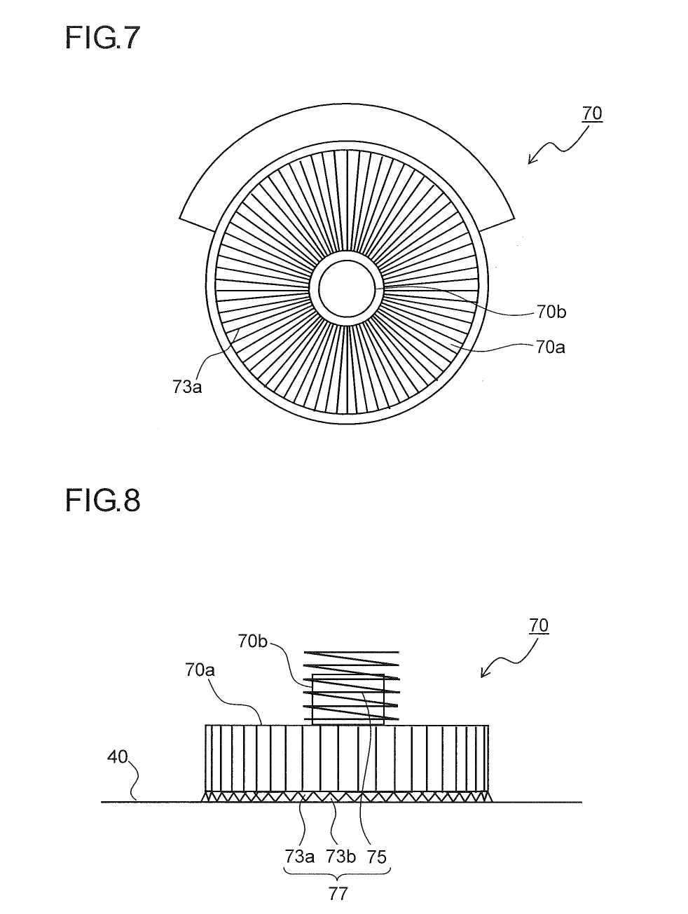

FIG. 7 is a plan view of the first gear 70 as seen from the side of its web face 70a facing the unit housing 40. FIG. 8 is a side view showing how first ratchet teeth 73a on the first gear 70 mesh with second ratchet teeth 73b on the unit housing 40. The web face 70a of the first gear 70 facing the unit housing 40 has first ratchet teeth 73a formed on it, and the unit housing 40 has second ratchet teeth 73b formed on it which mesh with the first ratchet teeth 73a. The first gear 70 has a boss portion 70b, which has fitted outside it a pressing spring 75 (third biasing member) that presses the first gear 70 toward the unit housing 40.

The pressing force of the pressing spring 75 keeps the first and second ratchet teeth 73a and 73b in a meshed state, and this restricts the rotation of the first gear 70. When the first gear 70 is rotated against the pressing force of the pressing spring 75, the first ratchet teeth 73a slide over, and move relative to, the second ratchet teeth 73b, causing a change in the position where the first and second ratchet teeth 73a and 73b mesh with each other. This permits the rotation of the first gear 70 to be stopped in a desired position, and it is thus possible to restrict the movement of the arm member 52 under the biasing force of the first coil spring 57 and thereby to prevent variation of the pressing force of the pickup roller 29. It is also possible to obtain a feel of operation (a feel of clicks) when rotating the first gear 70.

According to the embodiment described above, the pressing force adjusting mechanism 51 for adjusting the pressing force of the pickup roller 29 is provided within the sheet feed unit 117a. Thus, with the sheet feed unit 117a extracted out of the cassette-type sheet feeding section 101 in the image forming apparatus 100, the pressing force of the pickup roller 29 can be adjusted. Accordingly, when maintenance is performed with the sheet feed unit 117a extracted, it is possible to preform, in addition to removal of paper particles that have attached to the pickup roller 29 and the feed roller 30a, adjustment of the pressing force of the pickup roller 29.

The first gear 70, which doubles as an operation dial of the pressing force adjusting mechanism 51, is exposed to the front face side of the image forming apparatus 100 from an end part of the unit housing 40 in its insertion direction. Thus, even with the sheet feed unit 117a inserted in the unit insertion portion, the user can, simply by opening an exterior cover (unillustrated) of the image forming apparatus 100 and rotating the first gear 70, adjust the pressing force of the pickup roller 29. Moreover, the first gear 70 is exposed at a position where it can be operated even the sheet feed cassette 1a is inserted in the image forming apparatus 100. That is, irrespective of whether the sheet feed cassette 1a is inserted in or extracted out of the image forming apparatus 100, it is possible to adjust the pressing force of the pickup roller 29. This eliminates the need to extract the sheet feed cassette 1a every time the pressing force of the pickup roller 29 is adjusted, and thus contributes to improved operability.

Using the pressing force adjusting mechanism 51 according to the embodiment described above, it is possible to fine-adjust the pressing force of the pickup roller 29. For example, with the conventional adjustment method that involves changing the locked position of a torsion spring that biases the roller holder 31 in the pressing direction, it is possible to perform adjustment only, if there are two locked positions, in two steps and, if there are three locked positions, in three steps. According to the embodiment described above, it is possible, by reducing the interval (pitch) between the first ratchet teeth 73a formed on the web face 70a of the first gear 70 and the second ratchet teeth 73b formed on the unit housing 40, to perform adjustment in multiple steps.

By widening the movement range of the arm member 52 (link member 53) and giving the first coil spring 57 an adequate spring constant, it is possible to adjust the pressing force of the pickup roller 29 in a wide range. Thus, it is possible to adjust the pressing force of the pickup roller 29 appropriately for sheets of varying thicknesses, from thin sheets with a basis weight of about 40 g to thick sheets with a basis weight of about 400 g.

When the pickup roller 29 is retracted by the retracting mechanism 60, it is necessary to raise the roller holder 31 with a force stronger than the sum force of the pressing force acting on the roller holder 31 from the pressing mechanism 50 and the roller holder 31's own weight. Here, if the distance from the rotary shaft 41 to the point of application (depressed position) of the pressing force with which the roller holder 31 is depressed by the pressing member 55 differs from the distance from the rotary shaft 41 to the point of application (support position) of the raising force exerted by the holder support member 61, the vectors of the pressing force and the raising force acting on the roller holder 31 point in misaligned directions, making it difficult to adjust the balance of the pressing force.

In the embodiment described above, the depressed position at which the roller holder 31 is depressed by the pressing member 55 and the support position at which the roller holder 31 is supported by the holder support member 61 are at approximately equal distances from the rotary shaft 41, and thus the vectors of the pressing force and the raising force acting on the roller holder 31 point in opposite directions, 180° apart from each other. This makes it easy to adjust the balance of the pressing force, and contributes to enhanced adjustment accuracy.

The direction and amount of rotation of the first gear 70 can be notified to suit the type of sheets used. It is thus possible to simplify the adjustment of the pressing force of the pickup roller 29, and to obtain enhanced adjustment accuracy. For example, when a type of sheets is selected on the operation potion 112 (see FIG. 1), information on the selected sheets (information on the thickness and size of the sheets) is transmitted to the control portion 113. Based on the transmitted information on the sheets, the control portion 113 displays, on a liquid crystal display portion in the operation potion 112, information on adjustment of the pressing force of the pickup roller 29 (an indication that opening the exterior cover makes it possible to adjust the first gear 70, the direction and amount of rotation of the first gear 70 that suit the selected sheets, etc.).

The present disclosure may be implemented in any other manner than in the embodiment described above, and allows for many modification without departure from the spirit of the present disclosure. For example, the embodiment described above deals with a configuration where operating the first gear 70 manually allows the adjustment of the pressing force of the pickup roller 29; instead, a motor for driving the first and second gears 70 and 71 may be provided so that the pressing force of the pickup roller 29 can be adjusted automatically.

The embodiment described above deals with a configuration where the arm member 52 is reciprocated by use of the first and second gears 70 and 71. Instead, also possible is a configuration where the arm member 52 is reciprocated by use of the first gear 70 alone, or a configuration where the arm member 52 is reciprocated by use of three or more gears including the first and second gears 70 and 71. The embodiment described above deals with a configuration where sheets fed out by the pick-up roller 29a are fed on one by one, while being separated, by the feed roller 30a and the retard roller 30b. Instead, a configuration is also possible where a separating pad is used in place of the retard roller 30b.

The embodiment described above deals with a configuration where the first ratchet teeth 73a, the second ratchet teeth 73b, and the pressing spring 75 are used as a restricting mechanism 77 for restricting the rotation of the first and second gears 70 and 71 under the biasing force of the first coil spring 57. Instead, any other configuration may be used to restrict the rotation of the first and second gears 70 and 71.

The present disclosure finds application in sheet feed units that are removably mounted in an image forming apparatus. According to the present disclosure, it is possible to provide a sheet feed unit that permits the pressing force of a pickup roller in a sheet feed unit removably mounted in an image forming apparatus to be adjusted with a simple structure irrespective of whether or not the sheet feed unit is mounted in the main body of the image forming apparatus.

What is claimed is:

1. A sheet feed unit comprising:
a unit housing removably mounted in an apparatus main body;
a roller holder supported on the unit housing so as to be swingable in an up-down direction;
a pickup roller rotatably supported at a swinging end of the roller holder, the pickup roller rotating, while in contact with a top face of sheets placed on a sheet placement plate in a sheet feed cassette removably mounted in the apparatus main body, and thereby feeding out the sheets;
a feed roller arranged on a downstream side of the pickup roller in a sheet feed direction;
a separating member forming a nip with the feed roller, the separating member feeding one by one, while separating, the sheets fed out by the pickup roller;
a pressing mechanism including:
a pressing member pressing down the swinging end of the roller holder;
a link member of which a tip end part makes contact with the pressing member; and
a first biasing member biasing the link member toward the pressing member; and
a pressing force adjusting mechanism including:
an arm member supported so as to be reciprocatable in a sheet width direction perpendicular to the sheet feed direction on the unit housing, the arm member supporting the link member movably in the sheet width direction; and
an operation dial making the arm member reciprocate,
wherein
the pressing force adjusting mechanism changes a biasing force acting from the first biasing member via the link member to the pressing member according to a movement amount of the arm member, and thereby adjusts a pressing force of the pickup roller against the top face of the sheets placed on the sheet placement plate.

2. The sheet feed unit according to claim 1, wherein
with the unit housing inserted in the apparatus main body, a part of the operation dial is exposed out of an upstream-side end part of the unit housing in an insertion direction thereof.

3. The sheet feed unit according to claim 2, wherein
the part of the operation dial is exposed at a position where the operation dial can be operated with the sheet feed cassette inserted in the apparatus main body.

4. The sheet feed unit according to claim 1, wherein
the pressing member is a member in a triangular shape as seen in a plan view, and is supported on the unit housing so as to be pivotable about, a rotary shaft provided at a first vertex of the triangular shape,
a tip end of the link member makes contact with a first side extending upward from the rotary shaft, and
at a second vertex at the end of a second side extending in the horizontal direction from the first vertex, a pressing portion is formed that presses a depressed piece on the roller holder.

5. The sheet feed unit according to claim 1, further comprising:
a retracting mechanism locating the roller holder selectively either in a sheet feeding position where the pickup roller is permitted to feed out sheets or in a retracted position where the roller holder is retracted to above the sheet feeding position.

6. The sheet feed unit according to claim 5, wherein
the retracting mechanism includes:
a holder support member being reciprocatable in directions perpendicular to the sheet feed direction, the holder support member raising the roller holder to the retracted position and supporting the roller holder therein when the sheet feed cassette is extracted out of the apparatus main body;
a contact member making contact with the sheet feed cassette to release the roller holder from support by the holder support member when the sheet feed cassette has been inserted up to a predetermined position in the apparatus main body; and
a second biasing member basing the holder support member in such a direction that the roller holder is raised to the retracted position,
wherein
the roller holder is depressed at a depressed position by the pressing member and the roller holder is supported at a support position by the holder support member, the depressed position and the support position are at approximately equal distances from a swing axis of the roller holder.

7. The sheet feed unit according to claim 1, further comprising:
a restricting mechanism restricting rotation of the operation dial by the biasing force of the first biasing member.

8. The sheet feed unit according to claim 7, wherein
the restricting mechanism includes:
a gear provided on the operation dial to transmit a driving force from the operation dial to the arm member;
first ratchet teeth formed on a web face of the gear;
second ratchet teeth formed on the unit housing and meshing with the first ratchet teeth; and
a third biasing member biasing the gear in such a direction that the first and second ratchet teeth come closer to each other.

9. An image forming apparatus comprising:
the sheet feed unit according to claim 1;
the sheet feed cassette; and
an image forming section forming an image on a sheet fed by the sheet feed unit.

10. The image forming apparatus according to claim 9, further comprising:
an operation portion selecting of type of the sheet;
a display provided on the operation portion;
a controller determining adjustment parameters of the pressing force of the pickup roller according to the type of the sheet selected on the operation portion, and display the adjustment parameters on the display portion.
